(19) United States
(12) Patent Application Publication
(10) Pub. No.: US 2003/0221163 A1
(43) Pub. Date: Nov. 27, 2003

(54) Using web structure for classifying and describing web pages

(75) Inventors: Eric J. Glover, North Brunwick, NJ (US); Stephen R. Lawrence, Mountain View, CA (US)

Correspondence Address: SCULLY SCOTT MURPHY & PRESSER, PC, 400 GARDEN CITY PLAZA, GARDEN CITY, NY, 11530

(73) Assignee: NEC Laboratories America, Inc., Princeton, NJ

(21) Appl. No.: 10/371,814

(22) Filed: Feb. 21, 2003

Related U.S. Application Data
(60) Provisional application No. 60/359,197, filed on Feb. 22, 2002.

(51) Int. Cl. G06F 17/00

(52) U.S. Cl. 715/501.1

(57) ABSTRACT

An enhanced method and system for the classification of a target web page and the description of a set of web pages web pages utilizing virtual documents, in which a virtual document comprises extended anchortext extracted from each of a plurality of web pages that includes at least one hyperlink citing each target web page.

### CROSS-REFERENCE

This application claims the benefit of a U.S. Provisional Application 60/359,197 filed Feb. 22, 2002, which is incorporated herein in its entirety.

### BACKGROUND OF THE INVENTION

1. Technical Field of the Invention

The present invention generally relates to classification and description of web pages. More particularly, the present invention is directed to an enhanced system and method for the classification of a target web page and the description of a set of web pages web pages utilizing virtual documents that account for the structure of World Wide Web (i.e., “Web”) to improve accuracy of the classification and the description.

2. Description of the Prior Art

The structure of the web is used to improve the organization, search and analysis of the information on the World Wide Web (i.e., “Web”). The information of the Web represents a large collection of heterogeneous documents, i.e., web pages. Recent estimates predict the size of the Web to be more than 4 billion pages. The web pages, unlike standard text documents, can include both multimedia (e.g., text, graphics, animation, video and the like) and connections to other documents, which are known in the art as hyperlinks. The hyperlinks have increasingly been used to improve the ability to organize, search and analyze the web pages on the Web. More specifically, hyperlinks are currently used for the following: improving web search engine ranking; improving web crawlers; discovering web communities; organizing search results into hubs and authorities; making predictions regarding similarity between research papers; and classifying target web pages.

A basic assumption made by analyzing a particular hyperlink is that the hyperlink is often created because of a subjective connection between an original web page (i.e., citing document or web page) and a web page linked to by the original web page (i.e., destination document or web page) via the hyperlink. For example, if a web page that an author generates is a web page about the author's hobbies, and the author likes to play scrabble, the author may decide to link the hobbies web page to an online game of Scrabble®, or to a home page of Hasbro©. Consequently, the assumption is that foregoing hyperlinks convey the intended meaning or judgment of the author regarding the connection of the destination web pages to the original citing web page.

On the Web, a hyperlink has two components: a destination universal resource locator (i.e., “URL”) and an associated anchortext describing the hyperlink. A web page author determines the anchortext associated with each hyperlink. For example, as mentioned above, the author may create a hyperlink pointing to the home page of Hasbro©, and the author may define the associated anchortext as follows: “My favorite board game's home page.” The personal nature of the anchortext allows for connecting words to destination web pages. Some web search engines, such as Google©, utilize the anchortext associated with web pages to improve their search results. Furthermore, such search engines allow web pages to be returned based on the keywords occurring in the inbound anchortext, even if the keywords do not occur on the web pages themselves, such as for example, returning <http://www.yahoo.com> for a query of a “web directory.”

The classification of a target web page on the Web into a category (or class) has been performed via a plurality of classification methods, typically based on the words that appear on a given web page. Some classification methods may consider the components of the given Web page, such as the title, or the headings, differently from other words on the web page. An underlying assumption in the text-based classification is that the contents of the target web page are meaningful for the classification of the web page, or that there are similarities between words on web pages in the same category or class. Unfortunately, some web pages may include no obvious clues (textual words or phrases) as to their intent, limiting the ability to classify theses web pages. For example, the home page of Microsoft™ Corporation <http://www.microsoft.com/> does not mention the fact that Microsoft™ sells operating systems. As another example, the home page of General Motors™ <http://www.gm.com/flash_homepage/>) does not state that General Motors™ is a car company, except for the term “motors” in the title or the term “automotive” inside a form field. To make matters worse, like a majority of the web pages on the Web, the General Motors General Motors™ home page does not have any meaningful metatags, which aid in the classification of the target web page. The metatags, which are components of the hypertext markup language (i.e., “HTML”) language used to write web pages, permit a web page designer to provide information or description of the web pages.

The determination of whether a target web page belongs to a given category (i.e., classification), even though the target web page itself does not have any obvious clues or the words in the target web page do not capture the higher-level notion of the target web page, represent a challenge—i.e., GM™ is a car manufacturer, Microsoft™ designs and sells operating systems, or Yahoo™ is a directory service. Because people who are interested in the target web page decide what anchortext is to be included in the target web page, the anchortext may summarize the contents of the target web page better than the words on the web page itself, such as, indicating that Yahoo™ is a directory service, or Excite@home used to be an Internet Service Provider (i.e., “ISP”). It has been proposed to utilize in-bound anchortext in the web pages that hyperlink to the target web page to help classify the target web page. For example, in research comparing the classification accuracy of classifying a target web page utilizing the full-text of the target web page and the classification accuracy of classifying a target web page utilizing the inbound anchortext in the hyperlinks pointing to the target web page, it was determined that the inbound anchortext alone was slightly less powerful than the full-text alone. In other research in which the inbound anchortext was extended to include text that occurs near the anchortext (in the same paragraph) and the nearby headings, a significant improvement in the classification accuracy was noted when using the hyperlink-based method as opposed to the full-text alone, although considering the entire text of “neighbor documents” seemed to harm the ability to classify the target web page as compared to considering only the text on the web page itself.

In view of the foregoing, it is therefore desirable to provide a simpler yet enhanced system and method for using extended anchortext for classifying a target web page into a category.

As mentioned above, the Web is already very large and is projected to get even larger, and one way to help people find useful web pages is a directory service (i.e., “Web directory”), such as Yahoo™ <http://www.yahoo.com/> or The Open Directory Project <http://www.dmoz.org/>. Typically, the directories of target web pages are manually created, and a person judges in which category or categories a target web page is to be included. For example, Yahoo™ includes “General Motors” into several categories: “Auto Makers”, “Parts”, “Automotive”, “B2B—Auto Parts”, and “Automotive Dealers”. Yahoo™ places itself also in several categories, including the category “Web Directories.” Unfortunately large Web directories are difficult to manually maintain, and may be slow to include new web pages. A first problem encountered is that the makeup of any given category may be arbitrary. For example Yahoo™ groups anthropology and archaeology together in one category under “social sciences,” while The Open Directory Project separates archaeology and anthropology into their own categories under “social sciences.” A second problem encountered is that initially a category may be defined by very few web pages, and classifying another page into that category may be difficult. A third problem encountered is the naming of a category. For example, given ten random botany pages, how would one know that the category should be named botany or that the category is related to biology? In the Yahoo™ category of botany, only two of six random web pages selected from that category mentioned the word “botany” anywhere in the text of the web page, although some web pages had the word “botany” in the associated URLs, but not in the text of the web pages.

In view of the foregoing problems associated with naming a category, it is further desirable to provide an enhanced system and method for describing a group web pages using extended anchortext.

### SUMMARY OF THE INVENTION

The present invention is directed to an enhanced system and method for using a virtual document comprising extended anchortext to determine whether a web page is to be classified into a given category. The present invention is further directed to providing an enhanced system and method for describing a group of web pages using a set of virtual documents comprising extended anchortexts.

According to an embodiment of the present invention, there is provided a method for generating a virtual document for a target web page, the target web page being associated with a universal resource locator, the method comprising the steps of: locating a plurality of universal resource locators associated with web pages that cite the target web page; downloading the web pages that cite the target web page or obtaining contents of the web pages; traversing each web page or obtained content for each web page to extract extended anchortext for at least one hyperlink that links each web page to the target web page; and creating a virtual document comprising the extracted extended anchortext of each web page.

According to another embodiment of the present invention, there is provided a system for generating a virtual document for a target web page, the target web page being associated with a universal resource locator, the system comprising: a backlink locator for locating a plurality of universal resource locators associated with web pages that cite the target web page; a web page downloader for downloading the web pages that cite the target web page or a data cache for obtaining contents of the web pages; an extended anchortext extractor for traversing each web page or obtained content for each web page to extract extended anchortext for at least one hyperlink that links each web page to the target web page; and an extended anchortext combiner for creating a virtual document comprising the extracted extended anchortext of each web page.

According to yet another embodiment of the present invention, there is provided a method for determining whether a target web page is to be classified into a category of similar web pages, the method comprising the steps of: generating a corresponding virtual document for the target web page, the virtual document comprising extended anchortext extracted from each of a plurality of web pages that includes at least one hyperlink citing the target web page; determining classification of the corresponding virtual document using a trained virtual document classifier; generating a classification output for the target web page, the classification output being representative of whether the target web page is to be classified into the category of similar web pages on the basis of the classification determination of the corresponding virtual document.

According to still another embodiment of the present invention, there is provided a system for determining whether a target web page is to be classified into a category of similar web pages, the system comprising: a virtual document generator for generating a corresponding virtual document for the target web page, the virtual document comprising extended anchortext extracted from each of a plurality of web pages that includes at least one hyperlink citing the target web page; and a virtual document classifier for determining classification of the corresponding virtual document and for generating a classification output for the target web page, the classification output being representative of whether the target web page is to be classified into the category of similar web pages on the basis of the classification determination of the corresponding virtual document.

According to a further embodiment of the present invention, there is provided a method for determining whether a target web page is to be classified into a category of similar web pages, the target web page being associated with a universal resource locator, the method comprising the steps of: generating a corresponding virtual document for the target web page, the virtual document comprising extended anchortext extracted from each of a plurality of web pages that includes at least one hyperlink citing the target web page; determining classification of the corresponding virtual document using a trained virtual document classifier; generating a classification output for the target web page, the classification output representative of whether the target web page is to be classified into the category of similar web pages on the basis of the classification determination of the corresponding virtual document; downloading the target web page or obtaining contents of the target web page; generating a classification output of the target web page utilizing a trained full-text classifier; and combining the classification output of the virtual document classifier and the classification output of the full-text classifier to generate a combined classification output for the target web page, representing whether the target web page is to be classified into the category of similar web pages.

According to yet a further embodiment of the present invention, there is provided a method a system for determining whether a target web page is to be classified into a category of similar web pages, the target web page being associated with a universal resource locator, the system comprising: a virtual document generator for generating a corresponding virtual document for the target web page, the virtual document comprising extended anchortext extracted from each of a plurality of web pages that includes at least one hyperlink citing the target web page; a virtual document classifier for determining classification of the corresponding virtual document and for generating a classification output for the target web page, the classification output representative of whether the target web page is to be classified into the category of similar web pages on the basis of the classification determination of the corresponding virtual document; a web page downloader for downloading the target web page or a data cache for obtaining contents of the target web page; a full-text classifier for generating a classification output of the target web page; a combiner for combining the classification output of the virtual document classifier and the classification output of the full-text classifier to generate a combined classification output for the target web page, representing whether the target web page is to be classified into the category of similar web pages.

According to still a further embodiment of the present invention, there is provided a method for generating a description of a set of web pages in a collection comprising a plurality of web pages, the method comprising the steps of: defining a positive set of web pages in the collection and a negative set of web pages representing all web pages or a random set of web pages in the collection; generating respective histograms for the positive set of web pages and the negative set of web pages, the generation of the respective histograms comprising: i) generating a virtual document for each target web page in the positive and negative sets, the virtual document comprising extended anchortext extracted from each of a plurality of web pages that includes at least one hyperlink citing each target web page in the positive and negative sets; ii) generating a document vector describing features in the virtual document for each target web page in the positive and negative sets; and iii) creating the respective histograms and updating the respective histograms based on the document vector of the virtual document for each target web page in the positive and negative sets; applying a predetermined threshold to the respective histograms for the positive set of web pages and the negative set of web pages to eliminate a plurality of non-descriptive features that occur in less than a predetermined percentage of web pages in the positive and negative sets, to thereby produce a listing of possible descriptive features; evaluating entropy for each possible descriptive feature in the listing of the possible descriptive features; and sorting the listing of the possible descriptive features according to the evaluated entropy for each descriptive feature and selecting a predetermined number of highest-ranked descriptive features to describe the positive set of web pages.

According to the last embodiment of the present invention, there is provided system for generating a description of a set of web pages in a collection comprising a plurality of web pages, the system comprising: a means for defining a positive set of web pages in the collection and a negative set of web pages representing all web pages or a random set of web pages in the collection; a histogram generator for generating respective histograms for the positive set of web pages and the negative set of web pages, the histogram generator comprising: i) a virtual document generator for generating a virtual document for each target web page in the positive and negative sets, the virtual document comprising extended anchortext extracted from each of a plurality of web pages that includes at least one hyperlink citing each target web page in the positive and negative sets; ii) a document vector generator for generating a document vector describing features in the virtual document for each target web page in the positive and negative sets; and iii) a histogram updater for creating the respective histograms and updating the respective histograms based on the document vector of the virtual document for each target web page in the positive and negative sets; a threshold applicator for applying a predetermined threshold to the respective histograms for the positive set of web pages and the negative set of web pages to eliminate a plurality of non-descriptive features that occur in less than a predetermined percentage of web pages in the positive and negative sets, to thereby produce a listing of possible descriptive features; an entropy evaluator for evaluating entropy of each possible descriptive feature in the listing of the possible descriptive features; and a feature ranking tool for sorting the listing of the possible descriptive features according to the evaluated entropy for each descriptive feature and selecting a predetermined number of highest-ranked descriptive features to describe the positive set of web pages.

### BRIEF DESCRIPTION OF THE DRAWINGS

The objects, features and advantages of the present invention will become apparent to one skilled in the art, in view of the following detailed description taken in combination with the attached drawings, in which:

FIG. 1 depicts an embodiment of an exemplary classification system that utilizes a virtual document generated for a target web page to classify the target web page into a category of similar web pages according to the present invention;

FIG. 2 depicts another embodiment of an exemplary classification system that combines a conventional full-text classifier and virtual document classifier according to FIG. 1 for classifying a target web page into a category of similar web pages according to the present invention;

FIG. 3 depicts the virtual document generator that generates a virtual document for a target web page represented by a URL according to the present invention;

FIG. 4 depicts an exemplary illustration of a virtual document and a plurality of citing web pages that comprise the virtual document according to the present invention;

FIG. 5 depicts an exemplary feature description or summarization system for describing or summarizing features in a set of positive documents of a collection of documents according to the present invention;

FIG. 6 depicts an exemplary histogram generation for generating a histogram of a set of positive documents in a collection according to the present invention; and

FIG. 7 depicts an exemplary histogram generation for generating a histogram of all or a set of random documents in a collection according to the present invention.

### DETAILED DESCRIPTION OF THE PREFERRED EMBODIMENT OF THE INVENTION

The present invention is directed to an enhanced system and method for determining whether a web page should be classified into a specific category using extended inbound anchortext. The present invention is further directed to providing an enhanced system and method for describing a group of web pages using extended inbound anchortext.

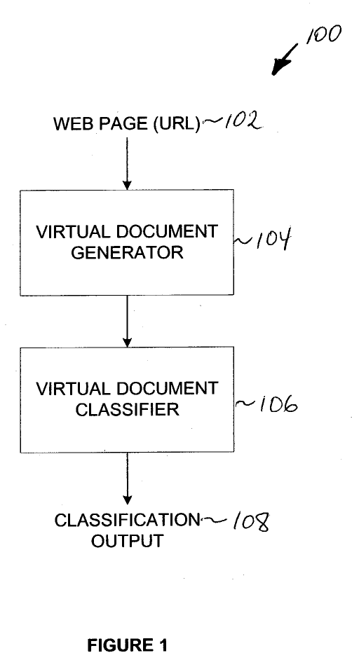

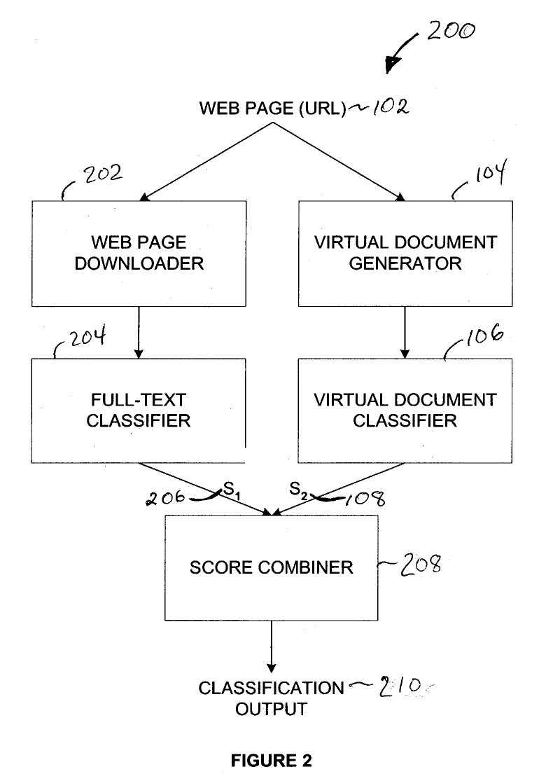

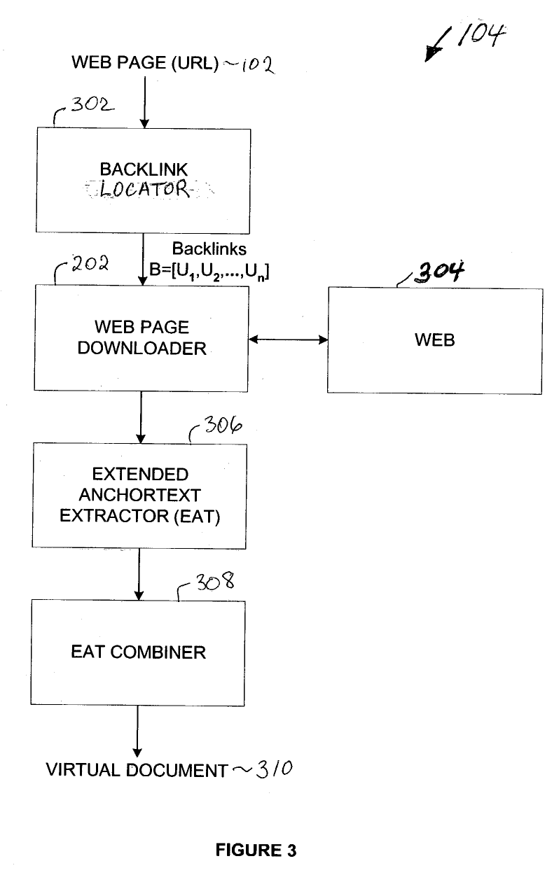

FIG. 1 depicts an embodiment of an exemplary classification system 100 that utilizes a virtual document associated with a target web page for classifying the target web page into a category of similar web pages according to the present invention. A universal resource locator (i.e., URL) 102 for the target web page to be classified is input into the classification system 100. A virtual document generator 104 generates a virtual document for the target web page 102 and inputs the generated virtual document into the virtual document classifier 106. The virtual document generator 104 is described below in FIG. 3. It is noted that the generated virtual document may easily be cached for future use without the necessity to regenerate the same virtual document again. The virtual document classifier 106, after being conventionally trained (not shown) using virtual documents according to the present invention, produces a prediction rule that determines a classification output 108, i.e., whether the target web page is to be classified into the category of the similar web pages. Although FIG. 1 depicts a high-level view of the virtual document classifier 106, it is noted that the virtual document classifier 106 comprises the logic of a conventional full-text classifier (FIG. 2), except for the fact of being trained using virtual documents according to the present invention. The virtual document classifier 106 comprises a learning algorithm (not shown), which is trained as described below to produce a prediction rule (not shown), which after the virtual document classifier is trained actually evaluates the virtual document for the target web page 102 to determine whether the corresponding target web page virtual document is a member of a positive set (not shown) or a negative set (not shown). As mentioned above, the virtual document classifier 106 comprises the learning algorithm (not shown) that accepts as input a set of labeled input virtual documents, where each virtual document in the set of virtual documents is assigned a label of whether the virtual document is a member of a positive set or a negative set. In the simplest form, the labels for a virtual document are either zero (0) or one (1), where 1 means that the virtual document is a member of the positive set and 0 means that the virtual document is not a member of the positive set. From the labeled input virtual documents the learning algorithm generates a prediction rule. After the virtual document classifier 106 is trained, a new unlabeled virtual document (i.e., virtual document generated by virtual document generator 104) can be evaluated by the prediction rule to predict its label, i.e., 0 if the new virtual document is not member of the positive set (negative set) and 1 if the new virtual document is a member of the positive set. The newly predicted label is the classification output 108, which signifies whether the target web page represented by URL 102 is to be a part of the category of similar web pages. Although there are many different learning algorithms that can be used according to the teaching of the present invention, an exemplary learning algorithm that is preferably used in the virtual document classifier 106 of the classification system 100 is a Support Vector Machine (i.e., “SVM”).

FIG. 2 depicts another embodiment of an exemplary classification system 200 that combines a conventional full-text classifier and virtual document classifier according to FIG. 1 for classifying a target web page into a category of similar web pages according to the present invention. Because the classification system 100 was described in detail in FIG. 1 above, the detailed description for the components 104, 106 and 108 of system 100 will be omitted here. It is noted here, that the classification output 108 will be referred to as a score S₁ 108. A URL 102 for the target web page to be classified is input into the classification system 200. A web page downloader 202 downloads the target web page associated with the URL 102, which was input into the classification system 200. The downloaded target web page is provided as input to a full-text classifier 204. It is contemplated within the scope of the present invention that the web page downloader 202 may easily be replaced by a data cache (not shown) or an index, which can easily provide the text for the target web page without having to download the target web page. The full-text classifier 204, after being trained (not shown) using web page documents, determines a classification output 206, i.e., whether the target web page is to be classified into the category of the similar web pages. The full-text classifier 204 comprises a learning algorithm (not shown), which is trained as described below to produce a prediction rule (not shown), which after the full-text classifier is trained actually evaluates the target web page to predict whether the target web page is a member of a positive set. As mentioned above, the full-text classifier 204 comprises the learning algorithm (not shown) that accepts as input a set of labeled input web pages, where each web page in the set of web pages is assigned a label of whether the web page is a member of a positive set or a negative set. That is, the labels for the web pages are either 0 or 1, where 1 means that the web page is a member of the positive set and 0 means that the web page is not a member of the positive set but a member of the negative set. From the labeled input web pages the learning algorithm generates a prediction rule. After the full-text classifier 204 is trained, a new unlabeled web page (i.e., target web page represented by URL 102) can be evaluated by the prediction rule to predict its label, i.e., 0 if the target web page is not member of the positive set (negative set) and 1 if the target web page is a member of the positive set. An exemplary learning algorithm that is preferably used in the full-text classifier 204 of the classification system 200 is a Support Vector Machine (i.e., “SVM”). A newly predicted label score S₂ 206 for the target web page represented by the URL 102 is the classification output 206, which signifies whether the target web page represented by URL 102 is to be a part of the category of similar web pages. The two scores S₁ 206 and S₂ 108 are input into a score combiner 208, which determines a classification output 210 representing whether the target web page is part of the category of web pages as follows. In the score combiner 208, if a determination is made that S₂ 108 is greater than zero (i.e., S₂>0), then the classification output 210 is positive (POS), i.e., the target web page represented by URL 102 is to be classified into the category of similar web pages. If S₁ 206 is not greater than zero then a determination is made as to whether S₂ 108 is less than negative one (S₂<−1). If S₂ 108 is less than negative one, then the classification output 210 is negative (NEG), i.e., the target web page represented by URL 102 is not classified into the category of similar web pages. If S₂ 108 is not less than negative one, a further determination is made as to whether S₁ 206 is greater than the absolute value of S₂ 108 (S₁>|S₂|). If S₁ 206 is greater than the absolute value of S₂ 108, then the classification output 210 is positive, otherwise the output classification is negative.

FIG. 3 depicts the virtual document generator 104 that generates a virtual document for a target web page represented by a URL according to the present invention. A URL 102 for the target web page is input into a backlink locator 302 that locates or obtains a set of URLs (B=U₁, U₂, . . . , Uₙ) associated with web pages that cite or hyperlink to the target web page. A search engine may have a web index that can easily be used to determine the set of URLs that cite or hyperlink to the target web page. The set of URLs is input into a web page downloader 202, which downloads the web pages associated with the URLs in the set from the Web 304 via known means, such as from a web server (not shown) using hypertext transfer protocol (i.e., “HTTP”) or other conventional means. As described above, if the contents of the web pages are available via a data cache or an index, then downloading the web pages is not necessary. In this case, the web page downloader 202 and web 304 may be substituted with the data cache or the index. The downloaded web pages are input into an extended anchortext (i.e., “EAT”) extractor 306, which traverses each downloaded web page and extracts the extended anchortext associated with the target web page. An EAT combiner 308 combines the extracted extended anchortext for each page web page and outputs virtual document 310 comprising the combined extended anchortext for all citing web pages.

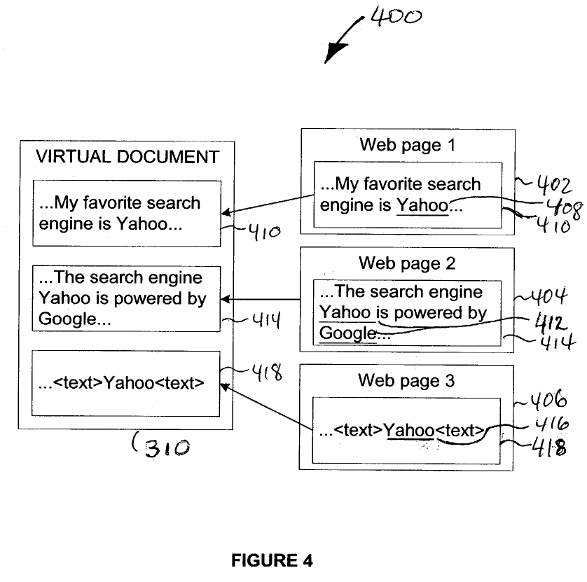

FIG. 4 is an exemplary illustration 400 of a virtual document and a plurality of citing web pages that comprise the virtual document according to the present invention. FIG. 4 is best understood in juxtaposition with FIG. 3. A URL 102 for the target web page is input into the backlink locator 302, which locates or obtains a set of URLs representing a plurality web pages, which the web page downloader 202 downloads from the Web 304. In exemplary fashion, that plurality of downloaded web pages is depicted in FIG. 4 as web page 1 (reference 402), web page 2 (reference 404) and web page 3 (reference 406). It is noted that the number of downloaded pages is not limited to three. As further depicted in FIG. 4, each citing web page 402, 404 and 406 respectively comprises at least one hyperlink 408, 412 and 416 to the target web page, which is in this case a hyperlink to a home page for “Yahoo.” Associated with each respective hyperlink for “Yahoo” 408, 412 and 416 is an extended anchortext 410, 414 and 418. The extended anchortext extractor 306 traverses each of the citing pages 402, 404 and 406 and extracts the extended anchortext 410, 414 and 418 associated with each hyperlink 408, 412 and 416. According to the present invention, the extracted extended anchortext comprises a predetermined number of words before the associated hyperlink and a predetermined number of words after the associated hyperlink. According to a preferable implementation of the present invention, the extracted extended anchortext is up to 25 words before the associated hyperlink and 25 words after the associated hyperlink. The EAT combiner 308 receives the extracted anchortext 410, 414 and 418 and creates the output virtual document 310, writing into the virtual document 310 the extracted anchortext 410, 414 and 418, which was extracted from each web page 402, 404 and 406, respectively.

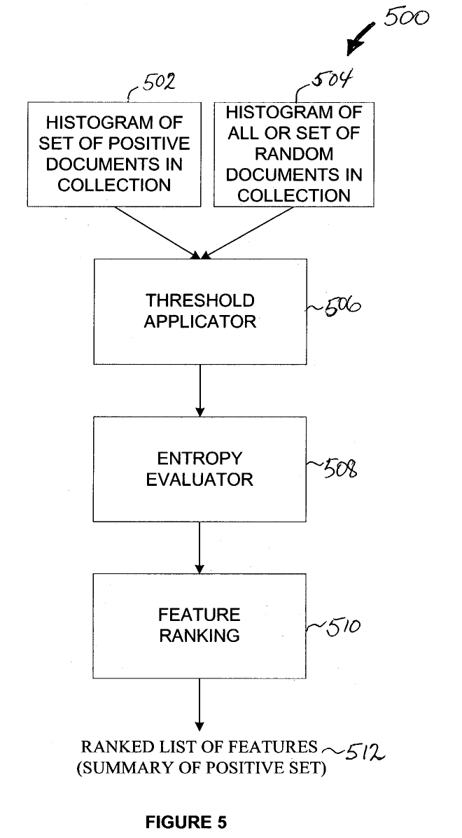

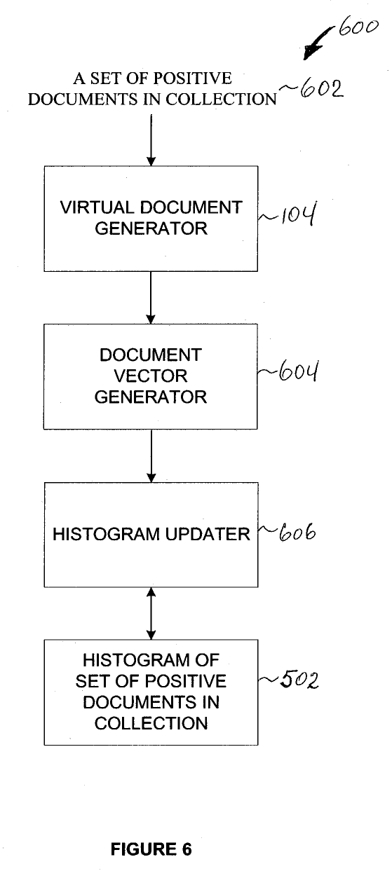

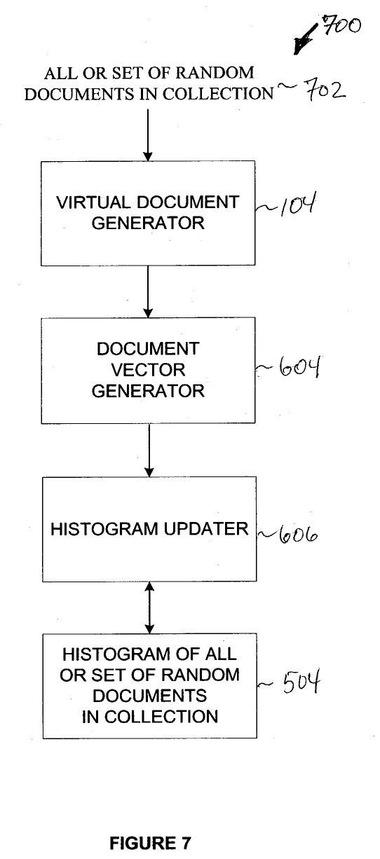

FIG. 5 represents an exemplary feature description or summarization system for describing or summarizing features in a set of positive documents (i.e., web pages) of a collection of documents according to the present invention. More specifically, the summarization system 500 takes as input a histogram of the set of positive documents 502 in a collection of documents and a histogram of all or a subset of random documents 504 in the collection of documents to generate a ranked list of features that form a set summary or description of the positive set of documents. The generation of the histogram for the positive set of document in the collection of documents 502 in accordance with the present invention will be described detail in FIG. 6 below. The generation of the histogram for all or a set of random documents in the collection of documents 504 will be described in detail in FIG. 7 below. The histogram 502 and the histogram 504 are input to a threshold applicator 506, which applies the following threshold to the two histograms to remove all features from the histograms that do not occur in a specified percentage of documents. A features removed if it occurs in less than a predetermined percentage of both histogram 502 and histogram 504. The following two inequalities specify the criteria for applying the threshold:|A_{f}|/|A|<T⁺ and |B_{f}|/|B|<T⁻. In the inequalities, A is a set of positive documents in the collection, B is a set of all or random documents in the collection, A_{f} are documents in A that include the feature f, B_{f} are documents in B that include the feature f, T⁺ is a threshold for positive features and T⁻ is a threshold for negative features. It is noted that the T⁺ threshold for the positive features may be different from the T⁻ threshold for the negative features. Thus, the threshold applicator 506 applies the foregoing criteria (threshold) to the histograms 502 and 504 to produce a list of features that satisfy either inequality, by removing features that violate both inequalities.

Further with reference to FIG. 5, the output of the threshold applicator 506 is input into an entropy evaluator 508, which computes the entropy for the features in the positive set of documents and all or set of random documents in the following manner. The entropy is computed independently for each feature as follows. Let C denote whether the document is a member of a specified category. Let f denote an event in the document that includes a specified feature (e.g., “evolution” in the title). Let \overline{C} and \overline{f} denote non-membership in the specified category and an absence of the specified feature, respectively. Prior entropy of the class distribution is e≡Pr(C) lg Pr(C)−Pr(\overline{C}) lg Pr(\overline{C}). A posterior entropy of the class when the specified feature is present is e_{f}≡−Pr(C|f) lg Pr(C|f)−Pr(\overline{C}|f) lg Pr(\overline{C}|f). Likewise, a posterior entropy of the class when the specified feature is absent is e−_{f}≡−Pr(C|\overline{f}) lg Pr(C|\overline{f})−Pr(\overline{C}|\overline{f}) lg Pr(\overline{C}|\overline{f}). Thus, an expected posterior entropy is e_{f} Pr(f)+e−_{f} Pr(\overline{f}), and the expected entropy loss is e−(e_{f} Pr(f)+e−_{f} Pr(\overline{f})). If any, of the probabilities are zero, such as a feature does not occur in the collection of documents, a fixed slightly positive value is used instead of zero. Likewise, if a feature occurs in every document of a class of either the positive set or the random or collect set, such that Pr(C|\overline{f})=0 or Pr(\overline{C}|\overline{f})=0, then a fixed value of slightly less than 1 is used. Because lg(0) is undefined, it causes expected entropy loss to be not-comparable if a feature occurs in all or none of either set of documents (i.e., positive set 502, set of all or random documents 504). Therefore, by using a fixed value that is non-zero, it is possible to fairly evaluate the features that do not exist in the negative set. Expected entropy loss is synonymous with expected information gain, and is therefore always non-negative. Consequently, the entropy evaluator 508 produces an output, which is then used to rank all of the features.

Still further with reference to FIG. 5, the output of the entropy evaluator 506 is input into a feature ranking tool 510, which sorts the features that meet the threshold by the expected entropy loss to provide an approximation of the usefulness of each individual feature. It is noted that the features that are “useful” will have high expected entropy loss scores, while features that are “not useful” will have low expected entropy loss scores. More specifically, the feature ranking tool 510 assigns a low score to a feature, such as the word “the,” which although common in both sets, is unlikely to be useful. The feature ranking 510 outputs a list of features 512 that summarizes or describe the positive set of documents in the collection as described below in FIG. 6. A set of top-ranked features is utilized as a summary of the positive set. The ranking of the features by the expected entropy loss (i.e., information gain) allows the determination of which words or phrases optimally separate a given positive set of documents from the rest of the documents in the collection (e.g., random or all documents in the collection), assuming all features are independent. Consequently, it is likely that the top-ranked features will meaningfully describe the positive set.

FIG. 6 is depicts an exemplary histogram generation 600 for generating a histogram of a set of positive documents in a collection 502 according to the present invention. A set of positive documents 602 in a collection of documents is input into a virtual documents generator 104, described in detail with reference to FIG. 3 above. The virtual document generator 104 generates a virtual document for each document in the positive set of documents 602. The set of virtual documents is input into a document vector generator 604 that generates vectors for each of the virtual documents. A document vector is a vector that describes the-features present in a virtual document. For example, a document whose title is “to be or not to be,” includes the words “be,” “not,” “or,” and “to” with respective counts of 2, 1, 1 and 2. In the preferred implementation of present invention, the document vector includes the features (i.e., words in the foregoing exemplary title as well as features that represent not only individual words, but also phrases (i.e., consecutive words), such as, “to be.” The output of the document vector generator 604 is input into a histogram updater 606 that generates and updates the histogram of the set of positive documents in the collection 502. According to the preferred implementation of the present invention, the histogram updater 606 does not consider the individual word (or the phrase) counts as depicted in the above example. The histogram updater 606 simply adds one to the histogram 502 for each feature present in the virtual document. That is, the histogram 502 represents a count of features such that a particular feature is counted only once per document in the positive set of documents 602, e.g., if a feature “biology” occurs a plurality of times in a given document, it is counted only once. At the end of the histogram generation, the histogram 502 will include a simple map between features (words and phrases) and the number of documents in the positive set that include the features. For example, there may be 100 positive documents in a category of “biology,” 15 of the documents may include the word “botany,” 97 of the documents may include the word “the,” and some number of the documents include the phrase “biology laboratory.” As described above, the threshold applicator 506 is used to remove poor features from consideration, the entropy evaluator 508 scores each remaining feature, and the feature ranking tool 510 sorts the features to predict which features are the most useful for describing the positive set.

FIG. 7 depicts an exemplary histogram generation 700 for generating a histogram for all or a set of random documents in a collection 504 according to the present invention. All or a set of random documents in a collection 702 is input into a virtual documents generator 104, described in detail with reference to FIG. 3 above. The method for generating the histogram of all or a random subset of documents 504 is identical to that described above for generating the positive set histogram 502. The only difference is that the input documents 702 represent documents from the collection as a whole, or a random subset, as opposed to the positive set in FIG. 6 above. The output of the histogram generation 700 is a histogram of all of set of random document in the collection 504.

While the invention has been particularly shown and described with regard to a preferred embodiment thereof, it will be understood by those skilled in the art that the foregoing and other changes in form and details may be made therein without departing from the spirit and scope of the invention.

Having thus described our invention, what we claim as new, and desire to secure by Letters Patent is:

1. A method for generating a virtual document for a target web page, the target web page being associated with a universal resource locator, the method comprising the steps of:
(a) locating a plurality of universal resource locators associated with web pages that cite the target web page;
(b) downloading the web pages that cite the target web page or obtaining contents of the web pages;
(c) traversing each web page or obtained content for each web page to extract extended anchortext for at least one hyperlink that links each web page to the target web page; and
(d) creating a virtual document comprising the extracted extended anchortext of each web page.

2. A method for generating a virtual document according to claim 1, wherein a web index is used for locating the plurality of universal resource locators that cite the target web page.

3. A method for generating a virtual document according to claim 1, wherein a data cache stores the contents of the web pages.

4. A method for generating a virtual document according to claim 1, wherein the extracted extended anchortext comprises a predetermined number of words before and a predetermined number of words after the at least one hyperlink hat links each web page to the target web page.

5. A method for generating a virtual document according to claim 4, wherein the predetermined number of words before the at least one hyperlink is 25 words and the predetermined number of words after the at least one hyperlink is 25 words.

6. A system for generating a virtual document for a target web page, the target web page being associated with a universal resource locator, the system comprising:
backlink locator for locating a plurality of universal resource locators associated with web pages that cite the target web page;
web page downloader for downloading the web pages that cite the target web page or a data cache for obtaining contents of the web pages;
extended anchortext extractor for traversing each web page or obtained content for each web page to extract extended anchortext for at least one hyperlink that links each web page to the target web page; and
extended anchortext combiner for creating a virtual document comprising the extracted extended anchortext of each web page.

7. A system for generating a virtual document according to claim 6, wherein the extracted extended anchortext comprises a predetermined number of words before and a predetermined number of words after the at least one hyperlink hat links each web page to the target web page.

8. A system for generating a virtual document according to claim 7, wherein the predetermined number of words before the at least one hyperlink is 25 words and the predetermined number of words after the at least one hyperlink is 25 words.

9. A method for determining whether a target web page is to be classified into a category of similar web pages, the method comprising the steps of:
(a) generating a corresponding virtual document for the target web page, the virtual document comprising extended anchortext extracted from each of a plurality of web pages that includes at least one hyperlink citing the target web page;
(b) determining classification of the corresponding virtual document using a trained virtual document classifier;
(c) generating a classification output for the target web page, the classification output being representative of whether the target web page is to be classified into the category of similar web pages on the basis of the classification determination of the corresponding virtual document.

10. A method for determining whether a target web page is to be classified into a category of similar web pages according to claim 9, wherein the step of generating a corresponding virtual document comprises the steps of:
locating a plurality of universal resource locators associated with web pages that cite the target web page;
downloading the web pages that cite the target web page or obtaining contents of the web pages;
traversing each web page or obtained content for each web page to extract extended anchortext for at least one hyperlink that links each web page to the target web page; and
creating the corresponding virtual document comprising the extracted extended anchortext of each web page.

11. A method for determining whether a target web page is to be classified into a category of similar web pages according to claim 9, wherein the method further comprises a step of training the virtual document classifier.

12. A method for determining whether a target web page is to be classified into a category of similar web pages according to claim 11, wherein the step of training the virtual document classifier comprises the steps of:
inputting a set of labeled virtual documents into the virtual document classifier, a label associated with each labeled virtual document representing whether each associated virtual document is a member of a positive set of virtual documents or a member of a negative set of virtual documents;
producing a prediction rule from the labeled set of virtual documents for determining a label of an unlabeled virtual document that is input into the virtual classifier during classification.

13. A system for determining whether a target web page is to be classified into a category of similar web pages, the system comprising:
a virtual document generator for generating a corresponding virtual document for the target web page, the virtual document comprising extended anchortext extracted from each of a plurality of web pages that includes at least one hyperlink citing the target web page; and
a virtual document classifier for determining classification of the corresponding virtual document and for generating a classification output for the target web page, the classification output being representative of whether the target web page is to be classified into the category of similar web pages on the basis of the classification determination of the corresponding virtual document.

14. A system for determining whether a target web page is to be classified into a category of similar web pages according to claim 13, wherein to generate the corresponding virtual document for the target web page the virtual document generator:
locates a plurality of universal resource locators associated with web pages that cite the target web page;
downloads the web pages that cite the target web page or obtains contents of the web pages;
traverses each web page or obtained content for each web page to extract extended anchortext for at least one hyperlink that links each web page to the target web page; and
creates the corresponding virtual document comprising the extracted extended anchortext of each web page.

15. A system for determining whether a target web page is to be classified into a category of similar web pages according to claim 13, wherein the virtual document classifier is trained.

16. A system for determining whether a target web page is to be classified into a category of similar web pages according to claim 15, wherein virtual document classifier training comprises the virtual document classifier:
inputting a set of labeled virtual documents into the virtual document classifier, a label associated with each labeled virtual document representing whether each associated virtual document is a member of a positive set of virtual documents or a member of a negative set of virtual documents; and
producing a prediction rule from the labeled set of virtual documents for determining a label of an unlabeled virtual document that is input into the virtual classifier during classification.

17. A method for determining whether a target web page is to be classified into a category of similar web pages, the target web page being associated with a universal resource locator, the method comprising the steps of:
(a) generating a corresponding virtual document-for the target web page, the virtual document comprising extended anchortext extracted from each of a plurality of web pages that includes at least one hyperlink citing the target web page;
(b) determining classification of the corresponding virtual document using a trained virtual document classifier;
(c) generating a classification output for the target web page, the classification output representative of whether the target web page is to be classified into the category of similar web pages on the basis of the classification determination of the corresponding virtual document;
(d) downloading the target web page or obtaining contents of the target web page;
(e) generating a classification output of the target web page utilizing a trained full-text classifier; and
(f) combining the classification output of the virtual document classifier and the classification output of the full-text classifier to generate a combined classification output for the target web page, representing whether the target web page is to be classified into the category of similar web pages.

18. A method for determining whether a target web page is to be classified into a category of similar web pages according to claim 17, wherein a data cache stores the contents of the target web page.

19. A method for determining whether a target web page is to be classified into a category of similar web pages according to claim 17, wherein the step of generating a corresponding virtual document comprises the steps of:
locating a plurality of universal resource locators associated with web pages that cite the target web page;
downloading the web pages that cite the target web page or obtaining contents of the web pages;
traversing each web page or obtained content for each web page to extract extended anchortext for at least one hyperlink that links each web page to the target web page; and
creating the corresponding virtual document comprising the extracted extended anchortext of each web page.

20. A method for determining whether a target web page is to be classified into a category of similar web pages according to claim 17, wherein the method further comprises a step of training the virtual document classifier.

21. A method for determining whether a target web page is to be classified into a category of similar web pages according to claim 20, wherein the step of training the virtual document classifier comprises the steps of:
inputting a set of labeled virtual documents into the virtual document classifier, a label associated with each labeled virtual document representing whether each associated virtual document is a member of a positive set of virtual documents or a member of a negative set of virtual documents; and
producing a prediction rule from the labeled set of virtual documents for determining a label of an unlabeled virtual document that is input into the virtual classifier during classification.

22. A method for determining whether a target web page is to be classified into a category of similar web pages according to claim 17, wherein the method further comprises a step of training the full-text classifier.

23. A method for determining whether a target web page is to be classified into a category of similar web pages according to claim 22, wherein the step of training the virtual document classifier comprises the steps of:
inputting a set of labeled web pages into the full-text classifier, a label associated with each labeled web page representing whether each associated web page is a member of a positive set of web pages or a member of a negative set of web pages; and
producing a prediction rule from the labeled set of web pages for determining a label of an unlabeled web page that is input into the virtual classifier during classification.

24. A method for determining whether a target web page is to be classified into a category of similar web pages according to claim 17, wherein the classification output of the full-text classifier is S₁ and the classification output of the virtual document classifier is S₂ and the combined classification output is:
classifying the target web page as positive for membership in the category of similar web pages if S₂ is greater than 0;
classifying the target web page as negative for membership in the category of similar web pages if S₂ is not greater than 0 and S₂ is less than −1;
classifying the target web page as positive for membership in the category of similar web pages if S₂ is not less than −1 and S₁ is greater than an absolute value of S₂; and
classifying the target web page as negative for membership in the category of similar web pages if S₂ is not less than −1 and S₁ is not greater than an absolute value of S₂.

25. A system for determining whether a target web page is to be classified into a category of similar web pages, the target web page being associated with a universal resource locator, the system comprising:
a virtual document generator for generating a corresponding virtual document for the target web page, the virtual document comprising extended anchortext extracted from each of a plurality of web pages that includes at least one hyperlink citing the target web page;
a virtual document classifier for determining classification of the corresponding virtual document and for generating a classification output for the target web page, the classification output representative of whether the target web page is to be classified into the category of similar web pages on the basis of the classification determination of the corresponding virtual document;
a web page downloader for downloading the target web page or a data cache for obtaining contents of the target web page;
a full-text classifier for generating a classification output of the target web page;
a combiner for combining the classification output of the virtual document classifier and the classification output of the full-text classifier to generate a combined classification output for the target web page, representing whether the target web page is to be classified into the category of similar web pages.

26. A system for determining whether a target web page is to be classified into a category of similar web pages according to claim 25, wherein to generate the corresponding virtual document for the target web page the virtual document generator:
locates a plurality of universal resource locators associated with web pages that cite the target web page;
downloads the web pages that cite the target web page or obtaining contents of the web pages;
traverses each web page or obtained content for each web page to extract extended anchortext for at least one hyperlink that links each web page to the target web page; and
creates the corresponding virtual document comprising the extracted extended anchortext of each web page.

27. A system for determining whether a target web page is to be classified into a category of similar web pages according to claim 25, wherein the virtual document classifier is trained.

28. A system for determining whether a target web page is to be classified into a category of similar web pages according to claim 27, wherein virtual document classifier training comprises the virtual document classifier:
inputting a set of labeled virtual documents into the virtual document classifier, a label associated with each labeled virtual document representing whether each associated virtual document is a member of a positive set of virtual documents or a member of a negative set of virtual documents; and
producing a prediction rule from the labeled set of virtual documents for determining a label of an unlabeled virtual document that is input into the virtual classifier during classification.

29. A system for determining whether a target web page is to be classified into a category of similar web pages according to claim 25, wherein the full-text classifier is trained.

30. A system for determining whether a target web page is to be classified into a category of similar web pages according to claim 29, wherein full-text classifier training comprises the full-text classifier:
inputting a set of labeled web pages into the full-text classifier, a label associated with each labeled web page representing whether each associated web page is a member of a positive set of web pages or a member of a negative set of web pages;
producing a prediction rule from the labeled set of web pages for determining a label of an unlabeled web page that is input into the virtual classifier during classification.

31. A system for determining whether a target web page is to be classified into a category of similar web pages according to claim 25, wherein the classification output of the full-text classifier is S₁ and the classification output of the virtual document classifier is S₂ and the combined classification output is:
classifying the target web page as positive for membership in the category of similar web pages if S₂ is greater than 0;
classifying the target web page as negative for membership in the category of similar web pages if S₂ is not greater than 0 and S₂ is less than −1;
classifying the target web page as positive for membership in the category of similar web pages if S₂ is not less than −1 and S₁ is greater than an absolute value of S₂; and
classifying the target web page as negative for membership in the category of similar web pages if S₂ is not less than −1 and S₁ is not greater than an absolute value of S₂.

32. A method for generating a description of a set of web pages in a collection comprising a plurality of web pages, the method comprising the steps of:
(a) defining a positive set of web pages in the collection and a negative set of web pages representing all web pages or a random set of web pages in the collection;
(b) generating respective histograms for the positive set of web pages and the negative set of web pages, the generation of the respective histograms comprising: i) generating a virtual document for each target web page in the positive and negative sets, the virtual document comprising extended anchortext extracted from each of a plurality of web pages that includes at least one hyperlink citing each target web page in the positive and negative sets; ii) generating a document vector describing features in the virtual document for each target web page in the positive and negative sets; and iii) creating the respective histograms and updating the respective histograms based on the document vector of the virtual document for each target web page in the positive and negative sets;
(c) applying a predetermined threshold to the respective histograms for the positive set of web pages and the negative set of web pages to eliminate a plurality of non-descriptive features that occur in less than a predetermined percentage of web pages in the positive and negative sets, to thereby produce a listing of possible descriptive features;
(d) evaluating entropy for each possible descriptive feature in the listing of the possible descriptive features; and
(e) sorting the listing of the possible descriptive features according to the evaluated entropy for each descriptive feature and selecting a predetermined number of highest-ranked descriptive features to describe the positive set of web pages.

33. A method for generating a description of a set of web pages according to claim 32, wherein the step of generating a virtual document for each target web page in the positive and negative sets comprises the following steps:
locating a plurality of universal resource locators associated with web pages that cite each target web page;
downloading the web pages that cite each target web page or obtaining contents of the web pages;
traversing each web page or obtained content for each web page to extract extended anchortext for at least one hyperlink that links each web page to each target web page; and
creating the corresponding virtual document comprising the extracted extended anchortext of each web page.

34. A system for generating a description of a set of web pages in a collection comprising a plurality of web pages, the system comprising:
a means for defining a positive set of web pages in the collection and a negative set of web pages representing all web pages or a random set of web pages in the collection;
a histogram generator for generating respective histograms for the positive set of web pages and the negative set of web pages, the histogram generator comprising: i) a virtual document generator for generating a virtual document for each target web page in the positive and negative sets, the virtual document comprising extended anchortext extracted from each of a plurality of web pages that includes at least one hyperlink citing each target web page in the positive and negative sets; ii) a document vector generator for generating a document vector describing features in the virtual document for each target web page in the positive and negative sets; and iii) a histogram updater for creating the respective histograms and updating the respective histograms based on the document vector of the virtual document for each target web page in the positive and negative sets;
a threshold applicator for applying a predetermined threshold to the respective histograms for the positive set of web pages and the negative set of web pages to eliminate a plurality of non-descriptive features that occur in less than a predetermined percentage of web pages in the positive and negative sets, to thereby produce a listing of possible descriptive features;
an entropy evaluator for evaluating entropy of each possible descriptive feature in the listing of the possible descriptive features; and
a feature ranking tool for sorting the listing of the possible descriptive features according to the evaluated entropy for each descriptive feature and selecting a predetermined number of highest-ranked descriptive features to describe the positive set of web pages.

35. A method for generating a description of a set of web pages according to claim 33, wherein the step of generating a virtual document for each target web page in the positive and negative sets comprises the following steps:
a backlink locator for locating a plurality of universal resource locators associated with web pages that cite each target web page;
a web page downloader for downloading the web pages that cite each target web page or a data cache for obtaining contents of the web pages;
an extended anchortext extractor for traversing each web page or obtained content for each web page to extract extended anchortext for at least one hyperlink that links each web page to each target web page; and
an extended anchortext combiner for creating the corresponding virtual document comprising the extracted extended anchortext of each web page.
